(19) United States
(12) Patent Application Publication
(10) Pub. No.: US 2025/0113271 A1
(43) Pub. Date: Apr. 3, 2025

(54) MOBILITY MANAGEMENT IN DISTRIBUTED COMPUTING

(71) Applicant: Apple Inc., Cupertino, CA (US)

(72) Inventors: Alperen Gundogan, Munich (DE); Amr Abdelrahman Yousef Abdelrahman Mostafa, Munich (DE); Christian Hofmann, Munich (DE); Panagiotis Botsinis, Munich (DE); Said Medjkouh, San Diego, CA (US); Sameh M. Eldessoki, Munich (DE); Seyedamirhossein Hosseini, San Diego, CA (US); Tarik Tabet, Carlsbad, CA (US)

(21) Appl. No.: 18/887,276

(22) Filed: Sep. 17, 2024

(30) Foreign Application Priority Data
Sep. 28, 2023 (GR) 20230100778

(51) Int. Cl. H04W 36/08; H04W 36/00; H04W 76/20

(52) U.S. Cl. CPC H04W 36/08; H04W 36/0058; H04W 76/20

(57) ABSTRACT

One or more processors are configured to execute instructions that cause a UE to perform operations. The operations include offloading a task to a first network node. The operations include determining a computation requirement forecast, wherein the computation requirement forecast indicates a computation requirement of the task at an upcoming time. The operations include transmitting the computation requirement forecast to the first network node. The operations include performing a handover procedure from the first network node to a second network node.

### CROSS REFERENCE TO RELATED APPLICATIONS

This application claims priority to Greek patent application No. 20230100778, filed Sep. 28, 2023, the content of which is incorporated herein by reference.

### BACKGROUND

Wireless communication networks provide integrated communication platforms and telecommunication services to wireless user devices. Example telecommunication services include telephony, data (e.g., voice, audio, and/or video data), messaging, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include time division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

Mobility is a desired feature of modern wireless user devices. A user who moves from one location to another often carries a user device, sometimes referred to as a user equipment (UE), while performing tasks that require stable wireless service. These tasks include, e.g., conducting a phone call, attending a virtual conference, and watching a streamed video. Because different geographical areas are often served by different cells, the movement of the UE may result in degradation of signal strength that the UE receives from a cell currently serving the UE (“serving cell” or “source cell”). To maintain its connection with the network, the UE may need to make a connectivity change, such as initiating a handover to another cell (“target cell”).

### SUMMARY

In accordance with one aspect of the present disclosure, one or more processors are configured to execute instructions that cause a UE to perform operations. The operations include offloading a task to a first network node. The operations include determining a computation requirement forecast, wherein the computation requirement forecast indicates a computation requirement of the task at an upcoming time. The operations include transmitting the computation requirement forecast to the first network node. The operations include performing a handover procedure from the first network node to a second network node.

In some implementations, offloading the task to the first network node includes: transmitting, to the first network node, a request to offload the task to the first network node; and receiving, from the first network node, a configuration for the UE to report the computation requirement according to at least one of a reporting periodicity or an event that triggers reporting.

In some implementations, the upcoming time corresponds to a granularity configured by the first network node or by a network entity. In some implementations, the upcoming time corresponds to a time when one or more conditions that trigger the handover procedure are satisfied.

In some implementations, the operations further include transmitting a measurement report via radio resource control (RRC) signaling to the first network node.

In some implementations, the measurement report includes the computation requirement forecast.

In some implementations, the operations further include: determining a priority between the computation requirement forecast and a communication continuity; and indicating the priority to the first network node.

In some implementations, performing the handover procedure includes: receiving computation capacity information of a plurality of candidate target network nodes; and selecting the second network node from the plurality of candidate target network nodes based on the computation capacity information.

In some implementations, the second network node satisfies the computation requirement forecast. The operations further include offloading the task to the second network node after performing the handover procedure.

In some implementations, the second network node does not satisfy the computation requirement forecast, and a latency between the first network node and the UE after the handover procedure is below a threshold. The UE receives data of the task forwarded by the second network node from the first network node via an Xn interface.

In accordance with one aspect of the present disclosure, one or more processors are configured to execute instructions that cause a first network node to perform operations. The operations include performing a task offloaded by a UE. The operations include receiving, from the UE, a computation requirement forecast, wherein the computation requirement forecast indicates a computation requirement of the task at an upcoming time. The operations include performing a handover procedure with the UE to hand over the UE from the first network node to a second network node.

In some implementations, the upcoming time corresponds to a granularity configured by the first network node or by a network entity. In some implementations, the upcoming time corresponds to a time when one or more conditions that trigger the handover procedure are satisfied.

In some implementations, the operations further include receiving a measurement report via RRC signaling from the UE.

In some implementations, the measurement report includes the computation requirement forecast.

In some implementations, the operations further include transmitting a handover request to the second network node, wherein the handover request includes the computation requirement forecast.

In some implementations, the operations further include transmitting a handover request to a plurality of candidate network nodes, wherein the handover request includes the computation requirement forecast.

In some implementations, the operations further include receiving a plurality of handover responses from the plurality of candidate network nodes; and selecting, based on the plurality of handover responses, the second network node from the plurality of candidate network nodes according to at least one of communication quality between each of the plurality of candidate network nodes and the UE or computation capability of each of the plurality of candidate network nodes.

In some implementations, the operations further transmitting, via radio resource control (RRC) signaling, a handover configuration message to the UE.

In some implementations, the handover configuration message includes a computation event configuration and a computation capability indication.

In some implementations, the operations further receiving, from the second network node, an indication of whether the second network node satisfies the computation requirement forecast.

In accordance with one aspect of the present disclosure, a UE includes one or more processors configured to execute instructions that cause the UE to perform operations. The operations include offloading a task to a first network node. The operations include determining a computation requirement forecast, wherein the computation requirement forecast indicates a computation requirement of the task at an upcoming time. The operations include transmitting the computation requirement forecast to the first network node. The operations include performing a handover procedure from the first network node to a second network node.

The details of one or more implementations of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates an example wireless network, according to some implementations.

FIG. 2 illustrates a scenario in which the movement of a UE triggers handover, according to some implementations.

FIGS. 3A and 3B together illustrate an example baseline handover procedure, according to some implementations.

FIGS. 4A and 4B together illustrate an example conditional handover procedure, according to some implementations.

FIGS. 5A and 5B each illustrate an example information element in which a UE can indicate computation requirements, according to some implementations.

FIG. 5C illustrates an architecture of a UE performing handover from a source xNB to a target xNB, according to some implementations.

FIGS. 6A and 6B each illustrate a flowchart of an example method, according to some implementations.

FIG. 7 illustrates an example UE, according to some implementations.

FIG. 8 illustrates an example access node, according to some implementations.

### DETAILED DESCRIPTION

When a UE performs a task, such as a complex computation, the UE may decide to offload the task to a node in the communication network (“network node” or “xNB” hereinafter), such as a base station, that has more resources for the task. When the network node completes the task, the network node transmits the result back to the UE in the format and within the timeframe desired by the UE. This mechanism, referred to as distributed computing, helps improve the efficiency of resource utilization across the network. Example applications of distributed computing include immersive media (e.g., augmented reality or virtual reality) processing, autonomous robot control, machine learning model training and inference, and compute-as-a-service.

A UE involved in distributed computing may need to be handed over from a source xNB to a target xNB. The handover can happen when, e.g., the UE is moving from a region covered by a cell of the source xNB to a region covered by a cell of the target xNB, or the computation resources (e.g., availability of processing and storage capacity) of the source xNB no longer satisfy the requirement of the task offloaded by the UE. Because existing handover techniques only consider signal measurements (e.g., Reference Signal Received Power [RSRP], Reference Signal Received Quality [RSRQ], Received Signal Strength Indicator [RSSI], and Signal to Interference and Noise Ratio [SINR]) between the UE and the xNBs and the network load corresponding to the xNBs, it is possible that, after being handed over to the target xNB, the UE experiences decreased or disrupted computation performance due to lack of computation resources at the target xNB.

This disclosure provides techniques to improve computation reliability in distributed computing. As described in detail below, implementations of this disclosure allow a UE and network nodes to consider computation requirements in addition to measurement results when making handover decisions. As such, likelihood of computation interruption can be reduced, and resource utilization and user experience can be improved.

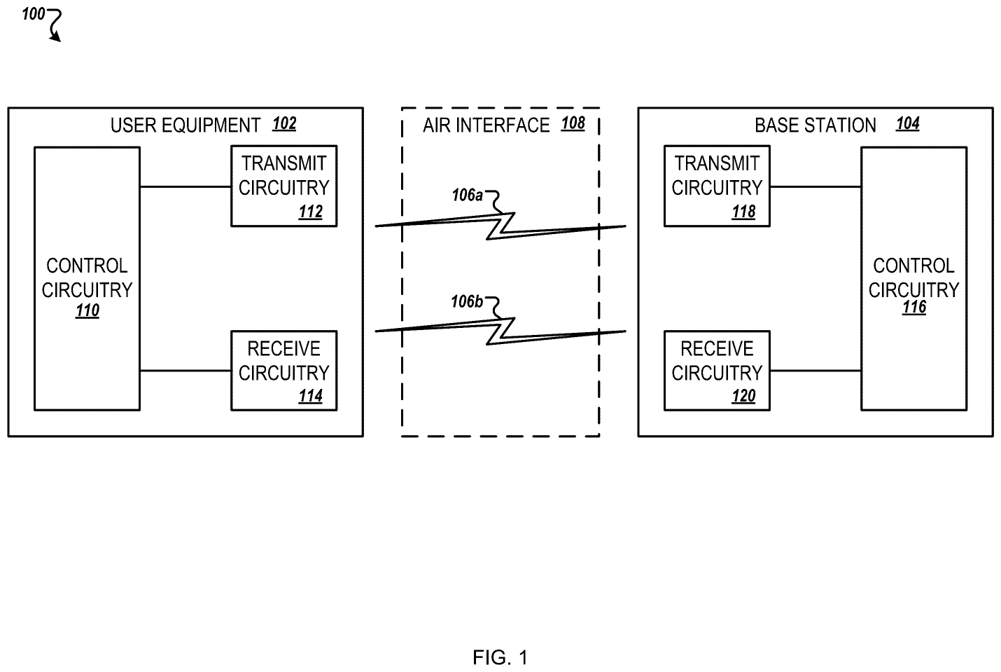

FIG. 1 illustrates a wireless network 100, according to some implementations. The wireless network 100 includes a UE 102 and a base station 104 connected via one or more channels 106A, 106B across an air interface 108. The UE 102 and base station 104 communicate using a system that supports controls for managing the access of the UE 102 to a network via the base station 104.

In some implementations, the wireless network 100 may be a Non-Standalone (NSA) network that incorporates Long Term Evolution (LTE) and Fifth Generation (5G) New Radio (NR) communication standards as defined by the Third Generation Partnership Project (3GPP) technical specifications. For example, the wireless network 100 may be a E-UTRA (Evolved Universal Terrestrial Radio Access)-NR Dual Connectivity (EN-DC) network, or an NR-EUTRA Dual Connectivity (NE-DC) network. In some other implementations, the wireless network 100 may be a Standalone (SA) network that incorporates only 5G NR. Furthermore, other types of communication standards are possible, including future 3GPP systems (e.g., Sixth Generation (6G)), Institute of Electrical and Electronics Engineers (IEEE) 802.11 technology (e.g., IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies), IEEE 802.16 protocols (e.g., WMAN, WiMAX, etc.), or the like. While aspects may be described herein using terminology commonly associated with 5G NR, aspects of the present disclosure can be applied to other systems, such as 3G, 4G, and/or systems subsequent to 5G (e.g., 6G).

In the wireless network 100, the UE 102 and any other UE in the system may be, for example, any of laptop computers, smartphones, tablet computers, machine-type devices such as smart meters or specialized devices for healthcare, intelligent transportation systems, or any other wireless device. In network 100, the base station 104 provides the UE 102 network connectivity to a broader network (not shown). This UE 102 connectivity is provided via the air interface 108 in a base station service area provided by the base station 104. In some implementations, such a broader network may be a wide area network operated by a cellular network provider, or may be the Internet. Each base station service area associated with the base station 104 is supported by one or more antennas integrated with the base station 104. The service areas can be divided into a number of sectors associated with one or more particular antennas. Such sectors may be physically associated with one or more fixed antennas or may be assigned to a physical area with one or more tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may include various combinations of application-specific circuitry and baseband circuitry. The transmit circuitry 112 and receive circuitry 114 may be adapted to transmit and receive data, respectively, and may include radio frequency (RF) circuitry and/or front-end module (FEM) circuitry.

In various implementations, aspects of the transmit circuitry 112, receive circuitry 114, and control circuitry 110 may be integrated in various ways to implement the operations described herein. The control circuitry 110 may be adapted or configured to perform various operations, such as those described elsewhere in this disclosure related to a UE. For instance, the control circuitry 110 can control transmit circuitry 112 and receive circuitry 114 to exchange configurations for handover and/or distributed computing.

The transmit circuitry 112 can perform various operations described in this specification. For example, the transmit circuitry 112 may transmit using a plurality of multiplexed uplink physical channels. The plurality of uplink physical channels may be multiplexed, e.g., according to time division multiplexing (TDM) or frequency division multiplexing (FDM) along with carrier aggregation. The transmit circuitry 112 may be configured to receive block data from the control circuitry 110 for transmission across the air interface 108.

The receive circuitry 114 can perform various operations described in this specification. For instance, the receive circuitry 114 may receive a plurality of multiplexed downlink physical channels from the air interface 108 and relay the physical channels to the control circuitry 110. The plurality of downlink physical channels may be multiplexed, e.g., according to TDM or FDM along with carrier aggregation. The transmit circuitry 112 and the receive circuitry 114 may transmit and receive, respectively, both control data and content data (e.g., messages, images, video, etc.) structured within data blocks that are carried by the physical channels.

FIG. 1 also illustrates the base station 104. In some implementations, the base station 104 may be a 5G radio access network (RAN), a next generation RAN, a E-UTRAN, a non-terrestrial cell, or a legacy RAN, such as a UTRAN. As used herein, the term “5G RAN” or the like may refer to the base station 104 that operates in an NR or 5G wireless network 100, and the term “E-UTRAN” or the like may refer to a base station 104 that operates in an LTE or 4G wireless network 100. The UE 102 utilizes connections (or channels) 106A, 106B, each of which includes a physical communications interface or layer.

The base station 104 circuitry may include control circuitry 116 coupled with transmit circuitry 118 and receive circuitry 120. The transmit circuitry 118 and receive circuitry 120 may each be coupled with one or more antennas that may be used to enable communications via the air interface 108. The transmit circuitry 118 and receive circuitry 120 may be adapted to transmit and receive data, respectively, to any UE connected to the base station 104. The receive circuitry 120 may receive a plurality of uplink physical channels from one or more UEs, including the UE 102.

In FIG. 1, the one or more channels 106A, 106B are illustrated as an air interface to enable communicative coupling, and can be consistent with cellular communications protocols, such as a UMTS protocol, a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any other communications protocol(s). In implementations, the UE 102 may directly exchange communication data via a ProSe interface. The ProSe interface may alternatively be referred to as a sidelink (SL) interface and may include one or more logical channels, including but not limited to a Physical Sidelink Control Channel (PSCCH), a Physical Sidelink Discovery Channel (PSDCH), and a Physical Sidelink Broadcast Channel (PSBCH).

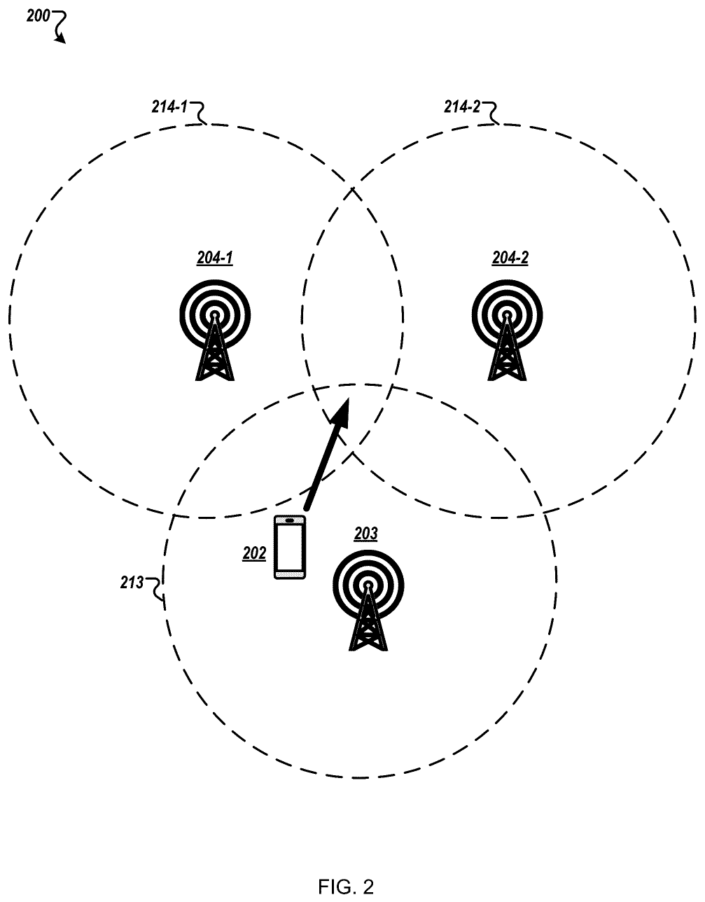

FIG. 2 illustrates a scenario 200 in which the movement of UE 202 triggers handover, according to some implementations. Scenario 200 involves three base stations 203, 204-1, and 204-2, corresponding to cells 213, 214-1, and 214-2, respectively. UE 202 can communicate with any of base stations 203, 204-1, and 204-2 in a manner similar to that described in FIG. 1.

As illustrated, UE 202 is currently in the coverage of cell 213 and is served by source base station 203. When UE 202 moves farther from source base station 203 towards the edge of cell 214, the measured signal strength between UE 202 and source base station 203 becomes weaker, which can trigger a handover event. As UE 202 moves into an area covered by both cells 214-1 and 214-2, UE 202 can be handed over to either of candidate target base stations 204-1 and 204-2.

The handover of UE 202 can be baseline handover or conditional handover. In baseline handover, the source base station sends a handover request to only one target base station upon making a handover decision, e.g., based on a measurement report from the UE. Once the target base station acknowledges the handover request, the source base station sends a handover command to the UE to provide the UE with configurations or reconfigurations used in the handover procedure. The UE and the target base station then starts the handover procedure by, e.g., performing a random access for the UE to establish communication with the target base station. Different from baseline handover, the source base station sends a handover request to multiple candidate target base stations upon making a handover decision to perform conditional handover, and yet the actual performance of the handover is contingent upon certain conditions are satisfied. For example, the source base station can configure the UE with one or more handover conditions, such as an A3 event based on signal measurements. The UE can evaluate the handover conditions and autonomously select a target base station for handover. Compared to baseline handover, conditional handover allows the UE to be configured with handover conditions at an earlier time than the actual performance of handover, which can reduce service interruption during handover. Whether a handover is a baseline handover or conditional handover, the handover can be triggered by a higher layer (e.g., Layer 3 [L3]) event or by a lower layer (e.g., Layer One or Layer Two [L1/L2]) event, and can happen to the UE with or without multi-connectivity (e.g., carrier aggregation).

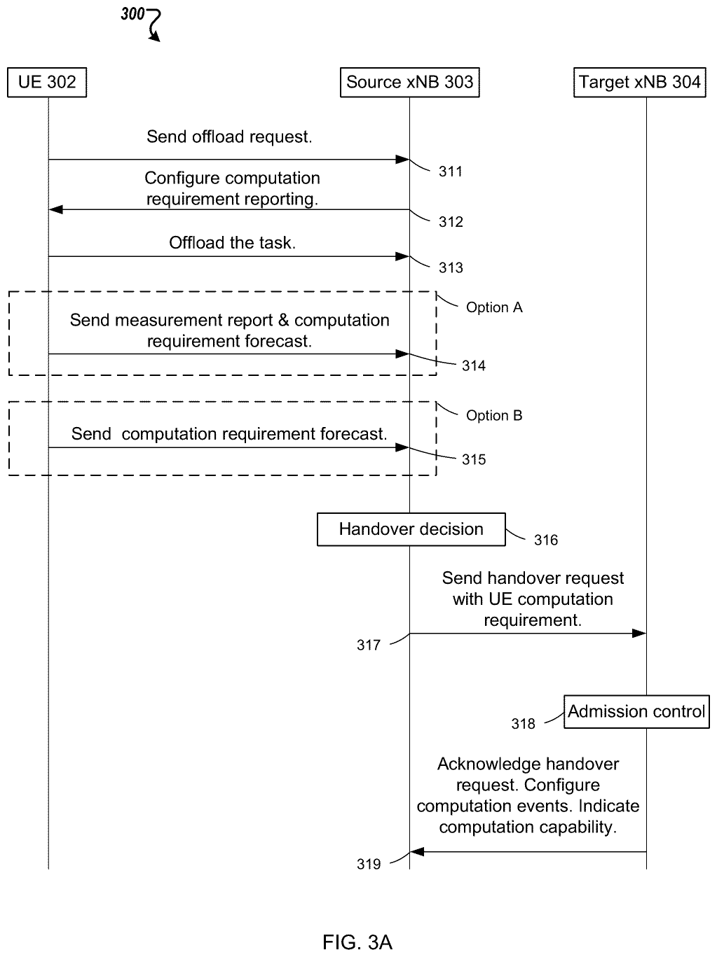

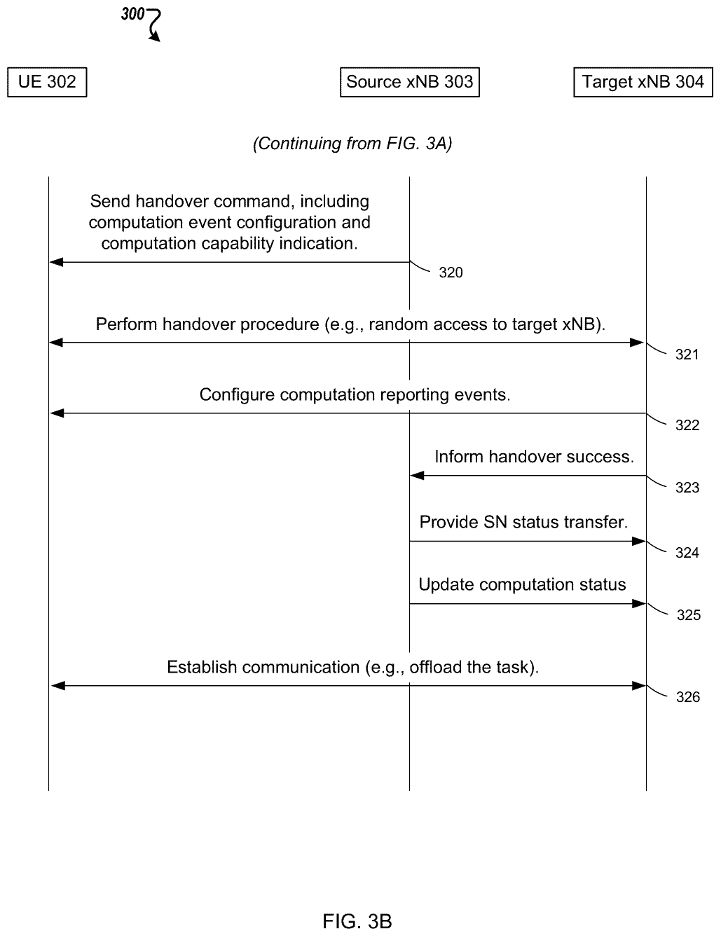

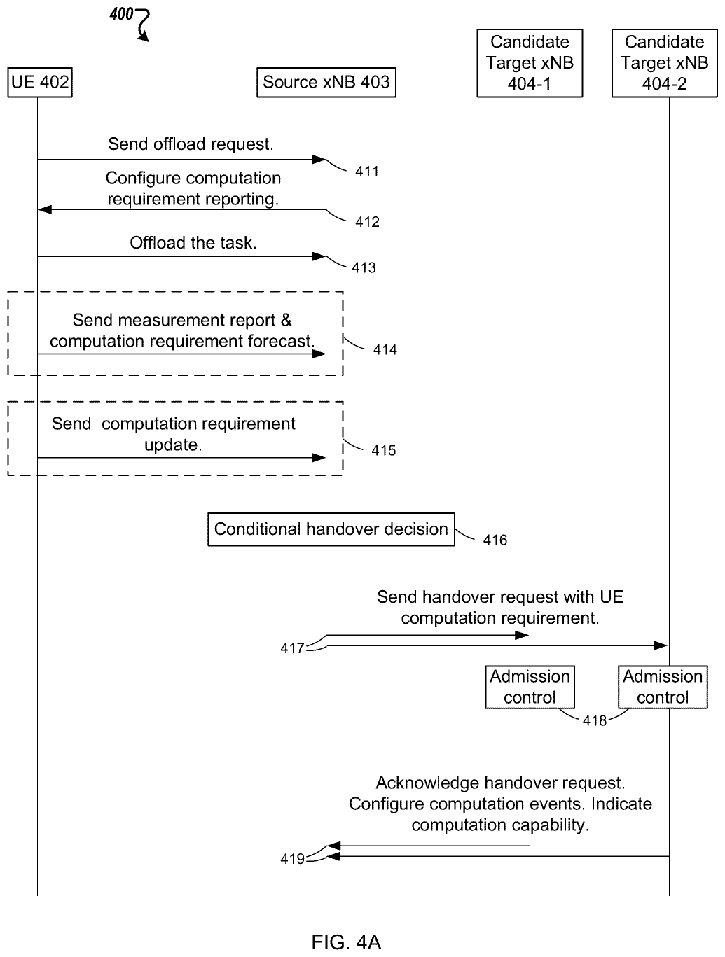

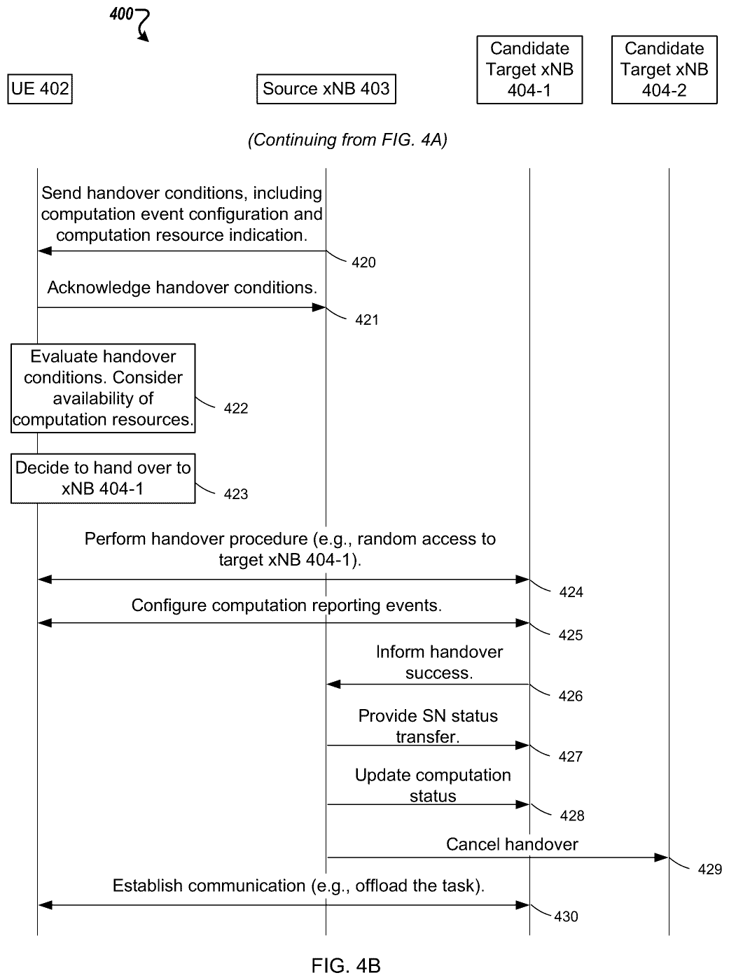

Implementations of this disclosure can apply to a variety of handover scenarios. Different from existing handover procedures, implementations of this disclosure consider, in addition to signal measurements, computation requirements of a task offloaded by a UE when making handover decisions. Depending on the computation capabilities of the target base station and the nature of the task, the UE may offload the task to the new source base station (i.e., the target base station prior to handover) or continue to offload the task to the old source base station (i.e., the source base station prior to handover). FIGS. 3A-4B below illustrate an example baseline handover procedure and an example conditional handover procedure in detail.

FIGS. 3A and 3B together illustrate an example baseline handover procedure 300, according to some implementations. Baseline handover procedure 300 involve UE 302, source xNB 303, and target xNB 304, which can be similar to UE 202, base station 203, and one of base stations 204-1 and 204-2, respectively.

Baseline handover procedure 300 begins with UE 302 offloading a task to source xNB 303. Specifically, at 311, UE 302 sends an offload request to source xNB 303. In response, at 312, source xNB 303 accepts the request and configures UE 302 to report computation requirements. For example, source xNB 303 can configure UE 302 to report UE 302's computation requirements periodically or when certain events happen. This way, source xNB 303 can timely track any changes of UE 302's computation requirements and adjust accordingly. At 312, UE 302 offloads the task to source xNB 303 by, e.g., providing source xNB 303 with parameters used in the task. Source xNB 303 can perform the task on its own, or outsource the task to one or more network entities that have available computation capacity.

UE 302 has Options A and B, configurable by source xNB 303, to report computation requirements. Under Option A, at 314, UE 302 sends computation requirements along with a measurement report, e.g., in a radio resource control (RRC) information element (IE) via an uplink channel (UL-SCH), to source xNB 303. Under Option B, at 315, UE 302 sends computation requirements in an IE, such as an RRC IE, separately from the measurement report. In the RRC IE of both options, UE 302 can include at least one of the current computation requirements or computation requirement forecast for a later, upcoming time, e.g., 500 milliseconds (ms) from the current time of sending the computation requirements, which can be configurable by source xNB 303, UE 302, or a network entity as a granularity variable. As described above, the reporting, which is to update source xNB 303 with UE 302's current and forecast computation requirements, can occur periodically or be triggered by an event. For example, when UE 302 forecasts a drastic increase in the computation requirements in the next 10 seconds and the amount of increase exceeds a threshold, UE 302 can report the forecast increase and/or the time of the increase to source xNB 303. In some implementations, the threshold for triggering the reporting event is configurable by source xNB 303 and depends on the computation capabilities of source xNB 303. If existing computation capabilities of source xNB 303 cannot satisfy the computation requirements after the increase, source xNB 303 can decide to hand UE 302 over to another xNB.

Source xNB 303 can configure UE 302 to adopt either or both of Options A and B. In some implementations, UE 302 can be configured with Option A when a handover is needed due to a change of signal strength between UE 302's and source xNB 303, such as due to UE 302's movement towards an edge of the cell coverage of source xNB 303. In some implementations, UE 302 can be configured with Option A when a handover is needed due to a change of computation resource availability for the offloaded task, such as due to a change of the task's computation requirements.

Based on the reporting of UE 302 in 314 or 315, source xNB 303 makes a handover decision at 316 to hand UE 302 over to target xNB 304, which can be a neighboring xNB with better signal strength or more computation capacity than source xNB 303. When there are multiple neighboring xNBs available for handover, source xNB 303 can select one based on the last received measurement that contains RSRP, RSRQ, and/or SINR measurements of the neighboring xNBs. The handover decision at 316 can also take into account a priority between the computation requirement forecast and communication continuity, which can be signaled by UE 302 at 314 or 315. For example, if UE 302 indicates that satisfying the computation requirement forecast is of higher priority than satisfying communication continuity, then source xNB 303 can decide to hand over UE 302 to the xNB with the most computation capacity. On the other hand, if UE 302 indicates that satisfying the computation requirement forecast is of lower priority than satisfying communication continuity, then source xNB 303 can decide to keep serving UE 302 for a longer period of time despite a potential decrease of computation speed, rather than hand over UE 302 to another xNB, which can cause disruption of communication continuity.

At 317, after making a handover decision, source xNB 303 sends a handover request to target xNB 304. Source xNB 303 can include UE 302's computation requirement forecast in the handover request. Source xNB 303 can also include an intermediate computation status of the task in the handover request.

At 318, target xNB 304 performs admission control to determine whether it can admit UE 302 under its service. Upon determining that target xNB 304 can admit UE 302 and satisfies UE 302's computation requirement forecast, target xNB 304 acknowledges the handover request at 319. In the acknowledgement, target xNB 304 can configure one or more computation events. Target xNB 304 can also indicate its computation capabilities along with the acknowledgement. If target xNB 304 determines, from the admission control at 318, that it can admit UE 302 but does not satisfy UE 302's computation requirement forecast, target xNB 304 can still admit UE 302 without accepting the offloaded task. For example, target xNB 304 can provide UE 302 with regular cellular services, while source xNB 303 can keep performing the offloaded task and forward the computation results to target xNB 304 via an Xn interface, provided that the latency between source xNB 303 and UE 302 caused by the forwarding is below a threshold. If target xNB 304 does not satisfy UE 302's computation requirement forecast and the latency between source xNB 303 and UE 302 exceeds the threshold, target xNB 304 can reject the handover request and inform source xNB 303 of the rejection.

At 320, upon receiving target xNB 304's acknowledgement to the handover request, source xNB 303 sends a handover command to UE 302. The handover command can include an RRC reconfiguration message. In the handover command, source xNB 303 can forward the computation event configurations and computation capability indications of target xNB 304 to UE 302.

At 321, UE 302 and target xNB 304 performs the handover procedure. For example, UE 302 can perform a random access procedure with target xNB 304.

At 322, upon completion of the handover procedure, target xNB 304 configures one or more events for UE 302 to report computation requirements (current and forecast), which can be similar to the reporting configured by source xNB 303 at 312. In some implementations, the configuration can be included in operations at 319-320. As such, the operations at 322 can be omitted.

From 323 to 325, source xNB 303 and target xNB 304 exchange a plurality of messages to upon successfully handing over UE 302 to target xNB 304. Specifically, target xNB 304 informs source xNB 303 of the success of handover at 323. Source xNB 303 then provides target xNB 304 with a sequence number (SN) status transfer and updates target xNB 304 with the intermediate computation status of the offloaded task.

At 326, UE 302 establishes communication with target xNB 304, which now is the source xNB after the handover. For example, UE 302 offload the task to target xNB 304 similarly to its offloading of the task to source xNB 303 at 311-313. After the handover, target xNB 304, UE 302, or a network entity can configure or reconfigure the granularity variable.

It is noted that not all operations of baseline handover procedure 300 are required. For example, in scenarios where source xNB 303 keeps performing the offloaded task after the handover to target xNB 304, operations at 322 and/or 325 can be omitted.

FIGS. 4A and 4B together illustrate an example conditional handover procedure 400, according to some implementations. Conditional handover procedure 400 involve UE 402, source xNB 403, candidate target xNB 404-1, and candidate target xNB 404-2, which can be similar to UE 202, base station 203, base station 204-1, and base station 204-2, respectively.

Operations from 411 to 415 can be similar to operations from 311 to 315, respectively, in baseline handover procedure 300. Descriptions of operations from 411 to 415 are thus omitted for brevity.

At 416, source xNB 403 makes a handover decision to hand UE 402 over to a target xNB, which can be one of candidate target xNBs 404-1 and 404-2. In some implementations where multiple xNBs are available in the area of UE 402, source xNB 403 can select candidate target xNBs 404-1 and 404-2 (and possibly other candidate target xNBs) from the available xNBs. In other words, source xNB 403 can select which xNBs have the potential of being the target xNBs in the conditional handover. Similar to the selection at 316 of baseline handover procedure 300, the selection at 416 can be based on the last received measurement that contains RSRP, RSRQ, and/or SINR measurements of the available xNBs. Alternatively or additionally, the selection at 416 can take into account information provided by UE 402, such as a priority between the computation requirement forecast and communication continuity. In some implementations, if source xNB 403 is aware of the computation capabilities of the available xNBs, source xNB 403 can select only the xNBs whose computation capabilities satisfy UE 402's computation requirement forecast.

In conditional handover procedure 400, the actual target xNB is not determined by source xNB 403 at 416. Rather, at 417, source xNB 403 sends a handover request to each of candidate target xNBs 404-1 and 404-2. In response, each of candidate target xNBs 404-1 and 404-2 performs admission control at 418 and acknowledges the handover request at 419. For each of candidate target xNBs 404-1 and 404-2, operations from 417 to 419 can be similar to operations 317 to 319 of baseline handover procedure 300. Descriptions of operations from 417 to 419 are thus omitted for brevity. As discussed above, source xNB 403, by making a handover decision at 416, has already selected candidate target xNBs 404-1 and 404-2 from possibly more available xNBs. Accordingly, the selection can help reduce network overhead by reducing the number of xNBs involved in operations 417 to 419.

At 420, source xNB 403 sends handover conditions to UE 402. The handover conditions can be included in an RRC reconfiguration message and can include, e.g., computation event configurations and computation capability indications that candidate target xNBs 404-1 and 404-2 sent to source xNB 403 at 419. Besides the computation events configured by candidate target xNBs 404-1 and 404-2, the handover conditions can include one or more computation events configured by source xNB 403. By configuring these computation events, source xNB 403 can specify one or more target xNBs that are prepared for a potential handover. For example, source xNB 403 can specify that, if UE 402 requires computation resources of between 2 petaFLOPs to 4 petaFLOPs in the next 10 seconds, UE 402 should be handed over to a specified targe xNB that satisfies such computation resource requirement. In addition to or alternative to computation events, the handover conditions can include one or more measurement events based on signal strength, such as an A3 event.

At 421, UE 402 sends an acknowledgement to the handover conditions. The acknowledgement can indicate, e.g., that UE 402 has completed RRC reconfiguration according to the message received at 420.

At 422, UE 402 evaluates the configured handover conditions and selects a candidate target xNB for handover. As described above, these handover conditions can include triggering of measurement events (e.g., due to UE 402's movement) and/or computation events (e.g., due to the change of computation requirements of UE 402). UE 402 can consider either or both of signal strength conditions and computation resource conditions to make the selection. For example, if a candidate target xNB communicates with UE 402 with stronger signal than source xNB 403 but the candidate target xNB has lower computation capacity than the source xNB, UE 402 may decide not to trigger the conditional handover.

At 423, upon determining that a handover condition (e.g., a handover condition configured by target xNB 404-1) is met, UE 402 decides to start the handover procedure by detaching from source xNB 403 and initiating connection with target xNB 404-1.

From 424-428 and 430, UE 402, source xNB 403, and target xNB 404-1 successfully perform the handover such that UE 402 becomes served by target xNB 404-1. These operations can be similar to operations at 321-326 of baseline handover procedure 300. Descriptions of operations at 424-428 and 430 are thus omitted. Similar to baseline handover procedure 300, UE 402 in some implementations may keep the offloaded task at source xNB 403 and have source xNB 403 forward the computation results to target xNB 404-1 via an Xn interface, provided that the latency between source xNB 403 and UE 402 with intervening target xNB 404-1 is below a threshold.

At 429, because UE 402 has decided to be handed over to target xNB 404-1, UE 402 informs candidate target xNB 404-2 to cancel the conditional handover with target xNB 404-2.

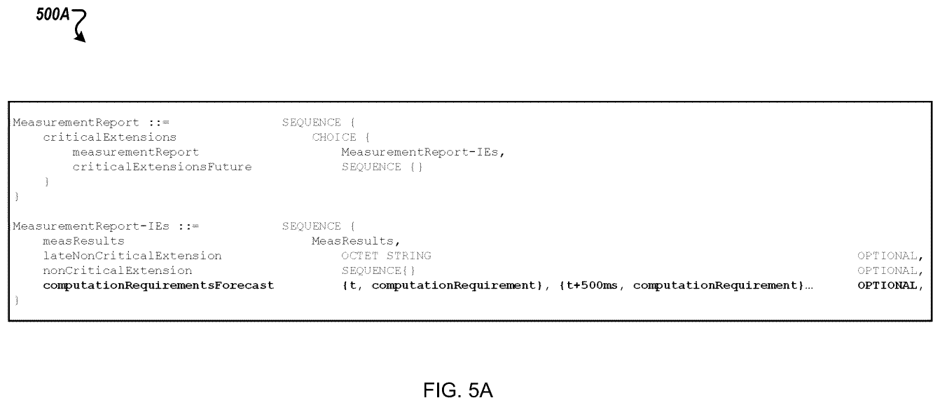

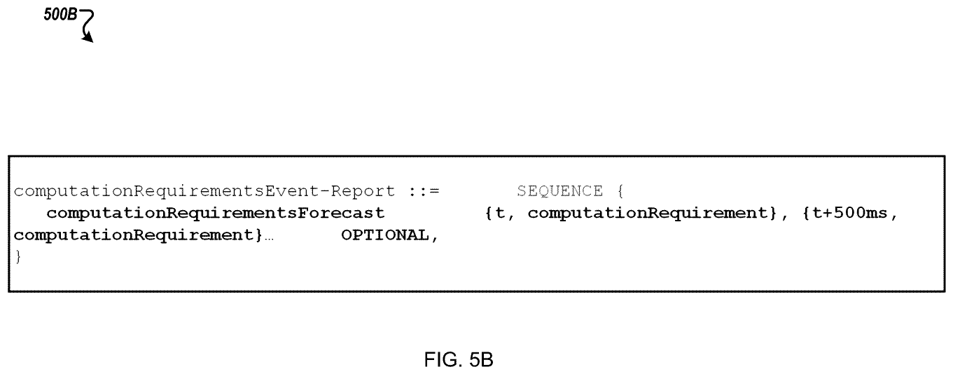

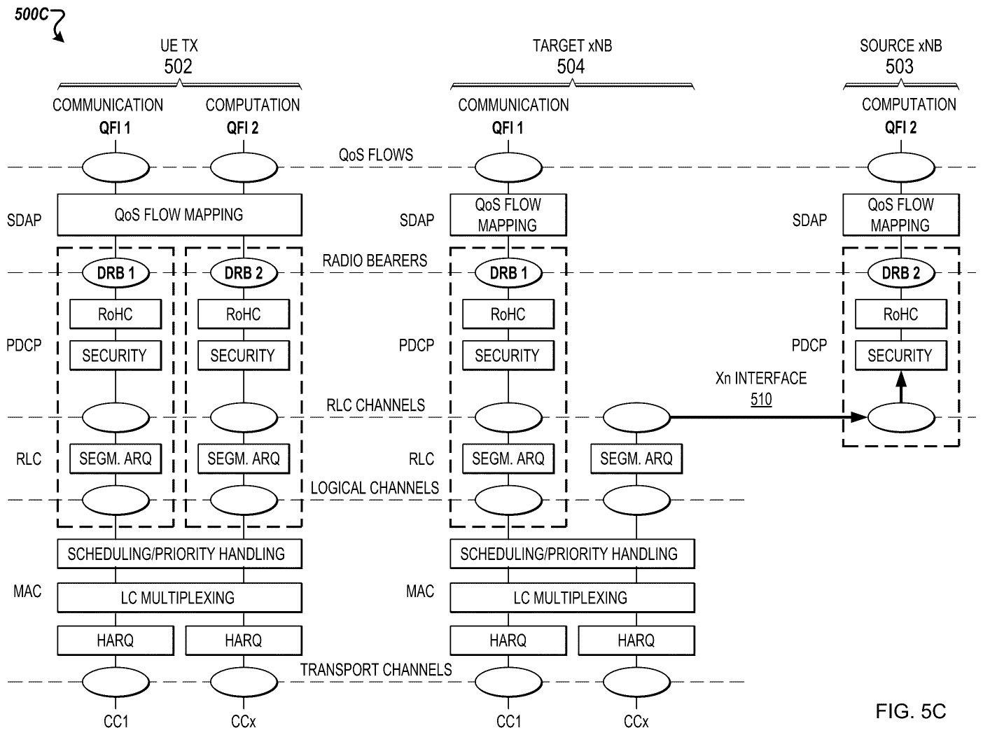

FIGS. 5A and 5B each illustrate an example IE, 500A and 500B, respectively, in which a UE can indicate computation requirements, according to some implementations.

IE 500A in FIG. 5A has an object MeasureReport-IE, which can be used to transmit a measurement report from a UE to a source xNB. MeasureReport-IE also has a field computationRequirementForecast, which can be used to transmit the UE's computation requirements (or computation requirement forecast) at time t and a period after t (500 ms in the example of IE 500A). Because of the structure of IE 500A, a UE can indicate both the measurement report and the computation requirement forecast in the same message. IE 500A thus can be used in operations such as 314 and 414.

IE 500B in FIG. 5B has an object computationRequirementEvent-Report, which can be separate from IEs for measurement reporting. The object computationRequirementEvent also has a field computationRequirementForecast, which can be used to transmit the UE's computation requirements (or computation requirement forecast) at time t and a period after t (500 ms in the example of IE 500B). Because IE 500B can be transmitted separately from IEs for measurement reporting, IE 500B can be used in operations such as 315 and 415.

FIG. 5C illustrates an architecture 500C of UE 502 performing handover from source xNB 503 to target xNB 504, according to some implementations. The handover can be similar to that performed in baseline handover procedure 300 or conditional handover procedure 400.

As illustrated in FIG. 5C, UE 502 includes a medium access control (MAC) layer, a radio link control (RLC) layer, a packet data convergence protocol (PDCP) layer, and a service data adaptation protocol (SDAP) layer, which correspond to counterpart layers of target xNB 504 after handover. Target xNB 504 and source xNB 503 are communicatively coupled by Xn interface 510.

As described above, in a scenario where UE 502 keeps the offloaded task at source xNB 503 after being handed over to target xNB 504, source xNB 503 sends the computation results to target xNB 504 via Xn interface 510, and target xNB 504 forwards the computation results to UE 502. In this case, UE 502 can keep a data radio bearer (DRB) that UE 502 and source xNB 503 used for the offloaded task prior to the handover. The DRB bearer kept can include, e.g., security and robust header compression (ROHC) functions handled by UE 502 based on source xNB 503's configurations. UE 502 can also create a new DRB for cellular communication data (as opposed to computation data associated with the offloaded task) transmitted between UE 502 and target xNB 504. As illustrated in FIG. 5C, UE 502 and source xNB 503 keep using DRB 2 for computation data, while UE 502 creates DRB 1 to be used with target xNB 504 for communication data. At the SDPA layer, UE 502 can map DRB 1 and DRB 2 to different Quality of service (QOS) flows, corresponding to different QoS flow indicators (QFI), QFI1 and QFI2, respectively. Meanwhile, source xNB 503 can retain the UE context and does not release the user plane bearer associated with the offloaded task.

Source x NB 503 and target xNB 504 establish a forwarding channel over Xn interface 510 for source xNB 503 to send computation results to target xNB 504. Over the forwarding channel, source xNB 503 can receive and process PDCP protocol data units (PDUs), which can be ciphered, from target xNB 504. In return, the PDCP layer entity of source xNB 503 can route the packets of the computation results to the RLC layer entity of target xNB 504 over Xn interface 510 for forwarding to UE 502.

In another scenario where UE 502 offloads the task to target xNB 504 after being handed over to target xNB 504, UE 502 can use the same DRB for both communication data and computation data. UE 502 can also re-establish its PDCP layer entity with a security key exchange of target xNB 504. In this scenario, source xNB 503 can discard and release the old DRB that it used with UE 502 before handover, after the completion of the handover.

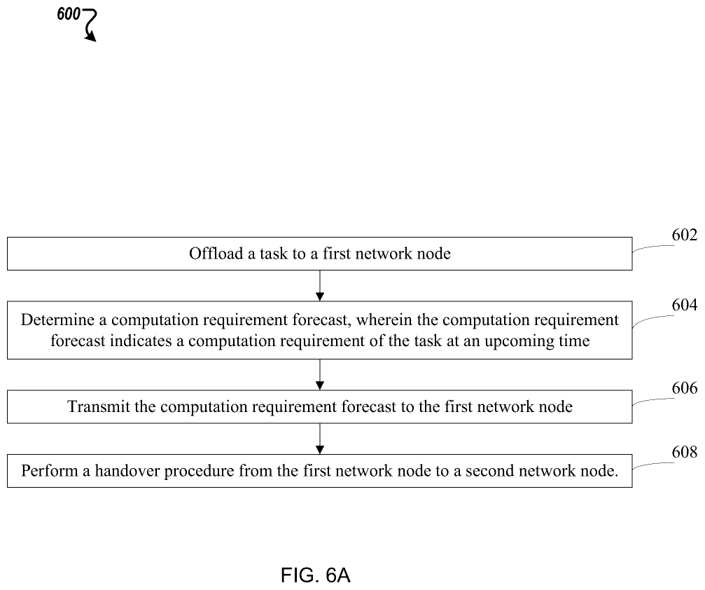

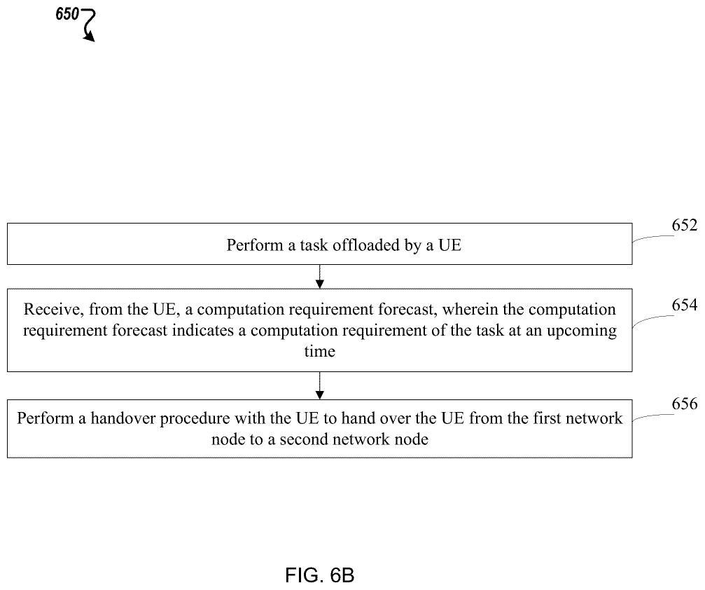

FIG. 6A illustrates a flowchart of an example method 600, according to some implementations. For clarity of presentation, the description that follows generally describes method 600 in the context of the other figures in this description. For example, method 600 can be performed by UE 102 of FIG. 1, UE 302 of FIGS. 3A-3B, or UE 402 of FIGS. 4A-4B. It will be understood that method 600 can be performed, for example, by any suitable system, environment, software, hardware, or a combination of systems, environments, software, and hardware, as appropriate. In some implementations, various steps of method 600 can be run in parallel, in combination, in loops, or in any order.

At 602, method 600 involves offloading a task to a first network node. The first network node can be a source xNB serving a UE.

At 604, method 600 involves determining a computation requirement forecast. The computation requirement forecast indicates a computation requirement of the task at an upcoming time.

At 606, method 600 involves transmitting the computation requirement forecast to the first network node. The transmission can be along with or separate from a measurement report based on signal strength.

At 608, method 600 involves performing a handover procedure from the first network node to a second network node. The handover procedure can be similar to baseline handover procedure 300 or conditional handover procedure 400.

FIG. 6B illustrates a flowchart of an example method 650, according to some implementations. For clarity of presentation, the description that follows generally describes method 650 in the context of the other figures in this description. For example, method 650 can be performed by a first network node, such as base station 104 of FIG. 1, source xNB 303 of FIGS. 3A-3B, or source xNB 403 of FIGS. 4A-4B. It will be understood that method 650 can be performed, for example, by any suitable system, environment, software, hardware, or a combination of systems, environments, software, and hardware, as appropriate. In some implementations, various steps of method 650 can be run in parallel, in combination, in loops, or in any order.

At 652, method 650 involves performing a task offloaded by a UE. The UE can be currently served by the first network node.

At 654, method 650 involves receiving, from the UE, a computation requirement forecast. The computation requirement forecast indicates a computation requirement of the task at an upcoming time.

At 656, method 650 involves performing a handover procedure with the UE to hand over the UE from the first network node to a second network node. The handover procedure can be similar to baseline handover procedure 300 or conditional handover procedure 400.

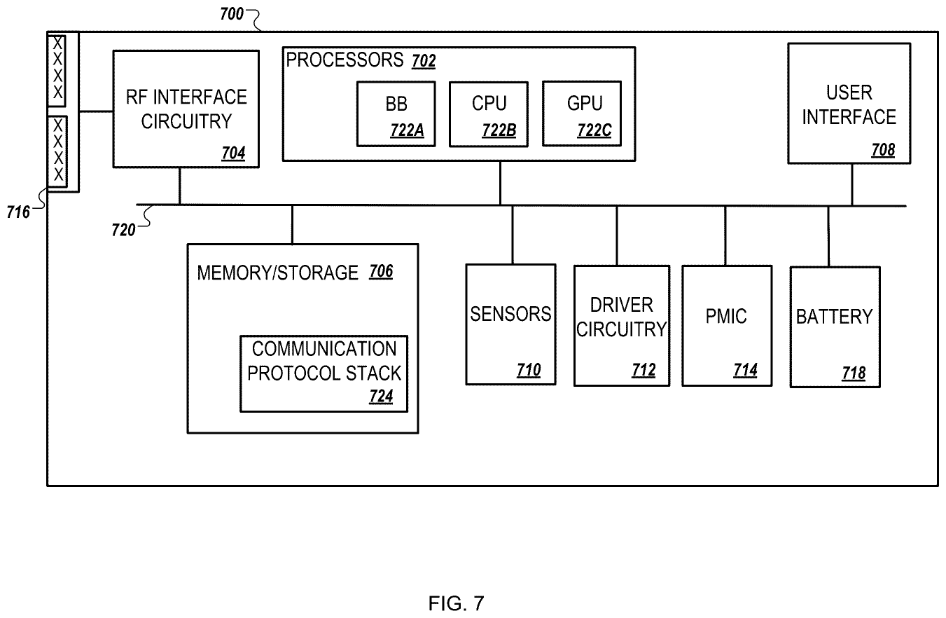

FIG. 7 illustrates an example UE 700, according to some implementations. The UE 700 may be similar to and substantially interchangeable with UE 102 of FIG. 1.

The UE 700 may be any mobile or non-mobile computing device, such as, for example, mobile phones, computers, tablets, industrial wireless sensors (for example, microphones, pressure sensors, thermometers, motion sensors, accelerometers, inventory sensors, electric voltage/current meters, etc.), video devices (for example, cameras, video cameras, etc.), wearable devices (for example, a smart watch), relaxed-IoT devices.

The UE 700 may include processors 702, RF interface circuitry 704, memory/storage 706, user interface 708, sensors 710, driver circuitry 712, power management integrated circuit (PMIC) 714, one or more antenna(s) 716, and battery 718. The components of the UE 700 may be implemented as integrated circuits (ICs), portions thereof, discrete electronic devices, or other modules, logic, hardware, software, firmware, or a combination thereof. The block diagram of FIG. 7 is intended to show a high-level view of some of the components of the UE 700. However, some of the components shown may be omitted, additional components may be present, and different arrangement of the components shown may occur in other implementations.

The components of the UE 700 may be coupled with various other components over one or more interconnects 720, which may represent any type of interface, input/output, bus (local, system, or expansion), transmission line, trace, optical connection, etc. that allows various circuit components (on common or different chips or chipsets) to interact with one another.

The processors 702 may include processor circuitry such as, for example, baseband processor circuitry (BB) 722A, central processor unit circuitry (CPU) 722B, and graphics processor unit circuitry (GPU) 722C. The processors 702 may include any type of circuitry or processor circuitry that executes or otherwise operates computer-executable instructions, such as program code, software modules, or functional processes from memory/storage 706 to cause the UE 700 to perform operations as described herein.

In some implementations, the baseband processor circuitry 722A may access a communication protocol stack 724 in the memory/storage 706 to communicate over a 3GPP compatible network. In general, the baseband processor circuitry 722A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 704. The baseband processor circuitry 722A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

The memory/storage 706 may include one or more non-transitory, computer-readable media that includes instructions (for example, communication protocol stack 724) that may be executed by one or more of the processors 702 to cause the UE 700 to perform various operations described herein. The memory/storage 706 include any type of volatile or non-volatile memory that may be distributed throughout the UE 700. In some implementations, some of the memory/storage 706 may be located on the processors 702 themselves (for example, L1 and L2 cache), while other memory/storage 706 is external to the processors 702 but accessible thereto via a memory interface. The memory/storage 706 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 704 may include transceiver circuitry and radio frequency front module (RFEM) that allows the UE 700 to communicate with other devices over a radio access network. The RF interface circuitry 704 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna(s) 716 and proceed to filter and amplify (with a low-noise amplifier) the signal. The signal may be provided to a receiver of the transceiver that downconverts the RF signal into a baseband signal that is provided to the baseband processor of the processors 702.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna(s) 716. In various implementations, the RF interface circuitry 704 may be configured to transmit/receive signals in a manner compatible with NR access technologies.

The antenna(s) 716 may include one or more antenna elements to convert electrical signals into radio waves to travel through the air and to convert received radio waves into electrical signals. The antenna elements may be arranged into one or more antenna panels. The antenna(s) 716 may have antenna panels that are omnidirectional, directional, or a combination thereof to enable beamforming and multiple input, multiple output communications. The antenna(s) 716 may include microstrip antennas, printed antennas fabricated on the surface of one or more printed circuit boards, patch antennas, phased array antennas, etc. The antenna(s) 716 may have one or more panels designed for specific frequency bands including bands in FR1 or FR2.

The user interface 708 includes various input/output (I/O) devices designed to enable user interaction with the UE 700. The user interface 708 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 700.

The sensors 710 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 712 may include software and hardware elements that operate to control particular devices that are embedded in the UE 700, attached to the UE 700, or otherwise communicatively coupled with the UE 700. The driver circuitry 712 may include individual drivers allowing other components to interact with or control various input/output (I/O) devices that may be present within, or connected to, the UE 700. For example, driver circuitry 712 may include a display driver to control and allow access to a display device, a touchscreen driver to control and allow access to a touchscreen interface, sensor drivers to obtain sensor readings of sensors 710 and control and allow access to sensors 710, drivers to obtain actuator positions of electro-mechanic components or control and allow access to the electro-mechanic components, a camera driver to control and allow access to an embedded image capture device, audio drivers to control and allow access to one or more audio devices.

The PMIC 714 may manage power provided to various components of the UE 700. In particular, with respect to the processors 702, the PMIC 714 may control power-source selection, voltage scaling, battery charging, or DC-to-DC conversion.

In some implementations, the PMIC 714 may control, or otherwise be part of, various power saving mechanisms of the UE 700. A battery 718 may power the UE 700, although in some examples the UE 700 may be mounted deployed in a fixed location, and may have a power supply coupled to an electrical grid. The battery 718 may be a lithium ion battery, a metal-air battery, such as a zinc-air battery, an aluminum-air battery, a lithium-air battery, and the like. In some implementations, such as in vehicle-based applications, the battery 718 may be a typical lead-acid automotive battery.

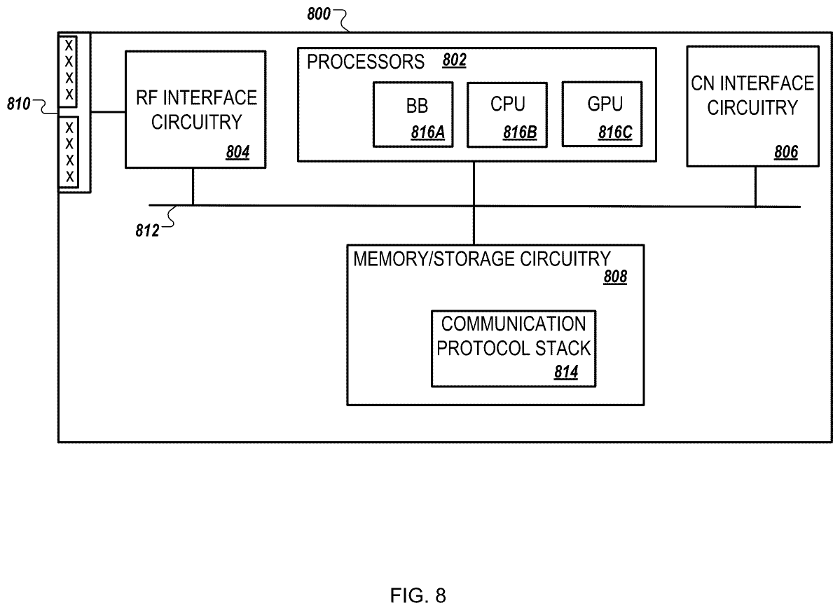

FIG. 8 illustrates an example access node 800 (e.g., a base station or gNB), according to some implementations. The access node 800 may be similar to and substantially interchangeable with base station 104. The access node 800 may include processors 802, RF interface circuitry 804, core network (CN) interface circuitry 806, memory/storage circuitry 808, and one or more antenna(s) 810.

The components of the access node 800 may be coupled with various other components over one or more interconnects 812. The processors 802, RF interface circuitry 804, memory/storage circuitry 808 (including communication protocol stack 814), antenna(s) 810, and interconnects 812 may be similar to like-named elements shown and described with respect to FIG. 7. For example, the processors 802 may include processor circuitry such as, for example, baseband processor circuitry (BB) 816A, central processor unit circuitry (CPU) 816B, and graphics processor unit circuitry (GPU) 816C.

The CN interface circuitry 806 may provide connectivity to a core network, for example, a 5th Generation Core network (5GC) using a 5GC-compatible network interface protocol such as carrier Ethernet protocols, or some other suitable protocol. Network connectivity may be provided to/from the access node 800 via a fiber optic or wireless backhaul. The CN interface circuitry 806 may include one or more dedicated processors or FPGAs to communicate using one or more of the aforementioned protocols. In some implementations, the CN interface circuitry 806 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 800 that operates in an NR or 5G system (for example, a gNB), and the term “E-UTRAN node” or the like may refer to an access node 800 that operates in an LTE or 4G system (e.g., an eNB). According to various implementations, the access node 800 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 800 may be implemented as one or more software entities running on server computers as part of a virtual network, which may be referred to as a CRAN and/or a virtual baseband unit pool (vBBUP). In V2X scenarios, the access node 800 may be or act as a “Road Side Unit.” The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112 (f) interpretation for that component.

Although the above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

As described above, one aspect of the present technology may relate to the gathering and use of data available from specific and legitimate sources to allow for interaction with a second device for a data transfer. The present disclosure contemplates that in some instances, this gathered data may include personal information data that uniquely identifies or can be used to identify a specific person. Such personal information data can include demographic data, location-based data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used to provide for secure data transfers occurring between a first device and a second device. The personal information data may further be utilized for identifying an account associated with the user from a service provider for completing a data transfer.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. For example, a user may “opt in” or “opt out” of having information associated with an account of the user stored on a user device and/or shared by the user device. In addition to providing “opt in” and “opt out” options, the present disclosure contemplates providing notifications relating to the access or use of personal information. For instance, a user may be notified upon downloading an application that their personal information data will be accessed and then reminded again just before personal information data is accessed by the application. In some instances, the user may be notified upon initiation of a data transfer of the device accessing information associated with the account of the user and/or the sharing of information associated with the account of the user with another device.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users based on aggregated non-personal information data or a bare minimum amount of personal information, such as the content being handled only on the user's device or other non-personal information available to the content delivery services.

What is claimed is:

1. One or more processors configured to execute instructions that cause a user equipment (UE) to perform operations comprising:
offloading a task to a first network node;
determining a computation requirement forecast, wherein the computation requirement forecast indicates a computation requirement of the task at an upcoming time;
transmitting the computation requirement forecast to the first network node; and
performing a handover procedure from the first network node to a second network node.

2. The one or more processors of claim 1, wherein offloading the task to the first network node comprises:
transmitting, to the first network node, a request to offload the task to the first network node; and
receiving, from the first network node, a configuration for the UE to report the computation requirement according to at least one of: a reporting periodicity, or an event that triggers reporting.

3. The one or more processors of claim 1, wherein the upcoming time corresponds to at least one of a granularity configured by the first network node or by a network entity, or a time when one or more conditions that trigger the handover procedure are satisfied.

4. The one or more processors of claim 1, the operations further comprising transmitting a measurement report via radio resource control (RRC) signaling to the first network node.

5. The one or more processors of claim 4, wherein the measurement report comprises the computation requirement forecast.

6. The one or more processors of claim 1, the operations further comprising:
determining a priority between the computation requirement forecast and a communication continuity; and
indicating the priority to the first network node.

7. The one or more processors of claim 1, wherein performing the handover procedure comprises:
receiving computation capacity information of a plurality of candidate target network nodes; and
selecting the second network node from the plurality of candidate target network nodes based on the computation capacity information.

8. The one or more processors of claim 1, wherein the second network node satisfies the computation requirement forecast, and wherein the operations further comprise offloading the task to the second network node after performing the handover procedure.

9. The one or more processors of claim 1, wherein the second network node does not satisfy the computation requirement forecast, wherein a latency between the first network node and the UE after the handover procedure is below a threshold, and wherein the UE receives data of the task forwarded by the second network node from the first network node via an Xn interface.

10. One or more processors configured to execute instructions that cause a first network node to perform operations comprising:
performing a task offloaded by a user equipment (UE);
receiving, from the UE, a computation requirement forecast, wherein the computation requirement forecast indicates a computation requirement of the task at an upcoming time; and
performing a handover procedure with the UE to hand over the UE from the first network node to a second network node.

11. The one or more processors of claim 10, wherein the upcoming time corresponds to at least one of a granularity configured by the first network node, or a time when one or more conditions that trigger the handover procedure are satisfied.

12. The one or more processors of claim 10, the operations further comprising receiving a measurement report via radio resource control (RRC) signaling from the UE.

13. The one or more processors of claim 12, wherein the measurement report comprises the computation requirement forecast.

14. The one or more processors of claim 10, the operations further comprising transmitting a handover request to the second network node, wherein the handover request comprises the computation requirement forecast.

15. The one or more processors of claim 10, the operations further comprising transmitting a handover request to a plurality of candidate network nodes, wherein the handover request comprises the computation requirement forecast.

16. The one or more processors of claim 15, the operations further comprising:
receiving a plurality of handover responses from the plurality of candidate network nodes; and
selecting, based on the plurality of handover responses, the second network node from the plurality of candidate network nodes according to at least one of: communication quality between each of the plurality of candidate network nodes and the UE, or computation capability of each of the plurality of candidate network nodes.

17. The one or more processors of claim 10, the operations further comprising: transmitting, via radio resource control (RRC) signaling, a handover configuration message to the UE.

18. The one or more processors of claim 17, wherein the handover configuration message comprises a computation event configuration and a computation capability indication.

19. The one or more processors of claim 10, the operations further comprising: receiving, from the second network node, an indication of whether the second network node satisfies the computation requirement forecast.

20. A user equipment (UE) comprising one or more processors configured to execute instructions that cause the UE to perform operations comprising:
offloading a task to a first network node;
determining a computation requirement forecast, wherein the computation requirement forecast indicates a computation requirement of the task at an upcoming time;
transmitting the computation requirement forecast to the first network node; and
performing a handover procedure from the first network node to a second network node.
